(19) United States
(12) Patent Application Publication
(10) Pub. No.: US 2003/0009331 A1
(43) Pub. Date: Jan. 9, 2003

(54) Grammars for speech recognition

(76) Inventors: Johan Schalkwyk, Somerville, MA (US); Michael S. Phillips, Belmont, MA (US)

Correspondence Address: J. ROBIN ROHLICEK, J.D., PH.D., Fish & Richardson P.C., 225 Franklin Street, Boston, MA, 02110-2804, US

(21) Appl. No.: 09/906,575

(22) Filed: Jul. 16, 2001

Related U.S. Application Data
(60) Provisional application No. 60/303,166, filed on Jul. 5, 2001.

(51) Int. Cl. G10L 15/12; G10L 15/08

(52) U.S. Cl. 704/237

(57) ABSTRACT

Pre-computed context-dependent phoneme representations of a number of constituents of a grammar are processed dynamically by a speech recognizer. The approach provides a configurable tradeoff between data size and recognition-time computation. This tradeoff can be obtained without sacrificing recognition accuracy, and in particular, allows full modeling of all cross-word phoneme contexts. In one aspect of the invention, a specification of a grammar is processed. This specification includes specifications of a number of constituents of the grammar. A first subset of the constituents of the grammar are selected, and the remaining of the constituents form a second subset. For each of the constituents in the first subset the method first includes processing the specification of the constituent to form a first processed representation that defines sequences of elements that are associated with that constituent and that includes words and references to constituents in the first subset. Forming the first processed representation of each constituent includes expanding references to constituents in the second subset according to the specifications of those constituents, and retaining references to constituents in the first subset without expanding said references.

### CROSS-REFERENCE TO RELATED APPLICATIONS

This application claims the benefit of U.S. Provisional Application No. __/___,___, titled “Grammars for Speech Recognition,” which was filed on Jul. 5, 2001. This provisional application is incorporated herein by reference.

### BACKGROUND

This invention relates to grammars for speech recognition.

One approach to specifying word sequences that can be processed by an automated speech recognizer uses a phrase-structured grammar, such as a context-free grammar. In such grammars, a number of rewrite rules are specified. Each rewrite rule has a “left-hand side,” which identifies a non-terminal symbol for which the rule specifies an allowable expansion, and a “right-hand side” which specifies the allowable expansion as a sequence of one or more elements. The elements of the expansion can be non-terminal symbols, which can be expanded according to one or more rules of the grammar, or can be terminal symbols, in this case words in the lexicon of the speech recognizer. One non-terminal symbol is identified as the “top level” symbol, which is associated with the complete set of valid sequences of terminal symbols in the language defined by the grammar. A well-known syntax for such grammars is the Backus-Naur Form (BNF). Various other syntaxes can also be used, for example, allowing optional and alternative sub-sequences of elements on the right-hand side of a rule. One such extended syntax is Extended BNF (EBNF).

Non-terminals in the grammar may be associated with semantically meaningful constituents, and identification of the words that are associated with those constituents aids in the interpretation of what was meant by the utterance. For example, a non-terminal may be associated with the structure of a date (e.g., “May twenty third”). The nested structure of the non-terminals can be identified in a word sequence that is hypothesized by a speech recognizer using one of a number of parsing algorithms. The output of such parsing algorithms can be a nested bracketing and labeling of the constituents of the word sequence. Such a bracketing can equivalently be represented as a parse tree, in which the leaves are associated with words and the interior leaves of the tree are each associated with non-terminals.

In automated speech recognition, one use of a word-level grammar is to constrain the recognizer to hypothesize only word sequences that fall within the language specified by the grammar. Advantages of constraining the recognizer in this way include increased accuracy, assuming that the speaker truly uttered a word sequence in the grammar. Furthermore, by avoiding consideration of the combinatorially large number of word sequences made up from words in the lexicon, the total amount of computation is reduced.

One approach to using a word-level grammar in automatic speech recognition is to represent the grammar as a finite-state machine, which is represented as a graph. The graph has a starting node and an ending node. Arcs are labeled with words. The labels on any path from the starting node to the ending node form word sequences in the language specified by the grammar, and any word sequence in the language is associated with at least one path from the starting node to the ending node. Subject to certain constraints limiting forms of recursion, a context-free grammar can be represented exactly as a finite-state machine. If the constraints are not satisfied, a finite-state machine can approximate the context-free grammar. During processing of an utterance containing an unknown word sequence, an automatic speech recognizer searches for a path through the graph that best represents the input utterance.

Typical high-accuracy speech recognizers represent words in terms of sequences of sub-word units, and perform recognition of utterances in terms of these sub-word units. A typically used sub-word unit is based on a phone. In a phonetically based speech recognizer, each word is represented as one or more sequences of phonemes. The alternative sequences for a word correspond to different pronunciations of the word. One representation of these alternative phoneme sequences is as a graph in which any path from the starting node to the ending node represents an allowable pronunciation.

In a phonetically based speech recognizer, one approach to incorporating the word-level grammar constraint as well as the phonetically based pronunciation constraint is to form a single combined finite state machine in which each word-arc of the word-level graph is replaced with the phoneme-level graph for the word on that arc. At run-time, the speech recognizer searches for a path through the single phoneme-level graph that best represents the input utterance. The speech recognizer then hypothesizes the word sequence associated with that phoneme-level path.

One approach to relating word sequences to their allowable phoneme paths is through the use of a finite-state “transducer.” A finite-state transducer is like a finite-state machine in that arcs are labeled with symbols, such as phonemes, that are “accepted” by the transducer. That is, an allowable phoneme sequence corresponds to the sequence of accepted symbols on arcs on a path from the start node to the end node. Each arc, in addition to having an accepted, or input, symbol, has a output symbol. In the case of a finite-state transducer that accepts phonemes and produces words, the input symbols are phonemes and the output symbols are words. Output symbols can also be null. These null outputs do not contribute to the output word sequence. Input symbols can also be null, thereby not having to correspond to any input symbol. This type of use of finite-state transducers in speech recognition is described in M. Mohri, “Finite-State Transducers in Language and Speech Processing,” Computational Linguistics, 23 (2), pp. 269-311, 1997.

Many phonetically-based speech recognizers associate phoneme labels with observations in the input utterance in such a way that the characteristics of the observations associated with a phoneme depend not only on the label of that phoneme, but also on the context of preceding and following phonemes in the hypothesized phoneme sequence. Such a recognizer is referred to as using “context-dependent” phonemes. For example, if the acoustic observations associated with a phoneme are characterized by a statistical model, the parameters of the model may depend on the label of that phoneme, as well as the label of the preceding and the following phoneme in a particular hypothesized phoneme sequence, in what is referred to as “triphone” modeling. Note however that in recognition, the following phoneme is not yet known while recognizing a current phoneme.

Some recognition systems take into account phonetic context within words. Others additionally take into account “cross-word” context. In cross-word context modeling, the last phoneme of a word can affect the characteristics of a first phoneme of a next word, and conversely, the first phoneme of the second word can affect the characteristics of the last phoneme of the first word. Generally, cross-word context modeling provides higher accuracy than context modeling that does not take into account the dependency between words.

One approach to introducing context-dependent models is to form a finite-state transducer, in which inputs of arcs are labeled according to the phoneme as well as the context for that phoneme. Any path from the starting node to the ending node is associated with an allowable phoneme sequence as in the case of a simple phoneme-based graph. Furthermore, the sequence of contexts of each of the phonemes along any path are consistent with the underlying sequence of phonemes. A method of forming a context-dependent phoneme graph from a simple phoneme graph is described in M. Riley, F. Pereira, and M. Mohri, “Transducer Composition for Context-Dependent Network Expansion,” in Proceedings of the 5th European Conference on Speech Communication and Technology (Eurospeech '97), Rhodes, Greece, 1997, and in M. Mohri and M. Riley, “Integrated Context-Dependent Networks in Very Large Vocabulary Speech Recognition,” in Proceedings of the 6th European Conference on Speech Communication and Technology (Eurospeech '99), Budapest, Hungary, 1999. This method involves manipulations of finite-state transducers using a composition operation in which a sequence of finite-state transducers is combined to form desired finite-state transducer.

Referring to FIG. 1, the process of forming a runtime grammar begins with a developer 110 specifying a context-free grammar 120, which includes a number of rules 122. A grammar compiler 130 is applied to rules 122 to form a finite-state machine grammar 140, such as a context-dependent phoneme based finite state transducer. FSM grammar 140 is then used at the time of recognition of an utterance by a speech recognizer 150.

An alternative to pre-expansion of a word-level grammar to form a finite-state machine or a finite-state transducer prior to recognizing an utterance is dynamic expansion of the grammar during the recognition process. In one such approach, the process of constructing a word-level graph is deferred until a particular non-terminal is encountered during recognition, and the word and phoneme level graph is constructed “on-the-fly.” A number of examples of such dynamic expansion are described in M. K. Brown and S. C. Glinski, “Context-Free Large-Vocabulary Connected Speech Recognition with Evolutionary Grammars,” in Proceedings Int. Conf. Acoustics Speech and Signal Processing, pp. II-145—II-148, Adelaide, Australia, 1994. In one such approach, a recursive transition network (RTN) is formed. The RTN includes a separate finite-state machine for each non-terminal that is on the left hand side of a grammar rule, and the paths through the graph associated with that non-terminal correspond to the possible sequences of elements (terminals and non-terminals) on the right-hand side of rules for that non-terminal. At recognition time, when a non-terminal is encountered on an arc, what is essentially a recursive “call” to the finite state machine for that non-terminal is made. Through these recursive calls, allowable word sequences are found without having to expand the grammar into a single overall network. In yet another alternative approach, a parsing procedure is integrated into the runtime recognizer which makes use of the phrase-structure grammar to predict allowable next words based on partial word hypotheses. Such alternative approaches are illustrated in FIG. 2. In these approaches, a developer 110 specifies a CFG grammar 120. However, rather than forming an expanded finite-state machine at configuration time prior to recognition, a speech recognizer 250 directly processes the phrase-structured form of the grammar.

Full expansion of a word-level grammar into a finite-state transducer which accepts context-dependent phonemes prior to recognition of an utterance can reduce the amount of computation required during the recognition phase and produces a large fully expanded grammar. On the other hand, recognition based on recognition-time processing of a phrases structured representation, for example using an RTN approach, requires additional computational effort during the recognition of an utterance and provides a compact representation of the language constraints.

### SUMMARY

The invention provides a way of combining aspects of pre-computation of context-dependent phoneme graphs as well as dynamic processing of grammar constraints to provide a configurable tradeoff between data size and recognition-time computation. This tradeoff can be obtained without sacrificing recognition accuracy, and in particular, allows full modeling of all cross-word phoneme contexts.

In one aspect, in general, the invention is method for speech recognition. A specification of a grammar is first accepted. This specification includes specifications of a number of constituents of the grammar. Each specification of one of the constituents defines sequences of elements associated with that constituent, where these sequences of elements include words and references to the constituents of the grammar. A first subset of the constituents of the grammar are selected, and the remaining of the constituents form a second subset. For each of the constituents in the first subset the method first includes processing the specification of the constituent to form a first processed representation that defines sequences of elements that are associated with that constituent and that includes words and references to constituents in the first subset. Forming the first processed representation of each constituent includes expanding references to constituents in the second subset according to the specifications of those constituents, and retaining references to constituents in the first subset without expanding said references. For each of the constituents in the first subset, the method further includes processing the first processed representation to form a second processed representation that defines sequences of elements that include subword units and references to constituents in the first subset. Configuration data that includes the second processed representation of each of the constituents in the first subset is then stored.

The method can include one or more of the following features.

The specification of the grammar includes a specification of a phrase-structure grammar, and the specification of each of the constituents includes a rewrite rule that specifies allowable substitutions of references to the constituent to include the sequences of elements associated with that constituent.

The specification of the phrase-structure grammar includes a context-free grammar.

The specification of the grammar is in Backus Naur Form (BNF).

Selecting the first subset of the constituents includes selecting those constituents according to static characteristics of the grammar.

Selecting the constituents according to a size of processed representations of those constituents.

Selecting the constituents according to a number of occurrences of those constituents in the grammar.

Selecting the constituents according to runtime characteristics of a speech recognizer using the grammar.

Selecting the constituents according to an expected processing time associated with the selection of those constituents.

Selecting the constituents according to a change in expected processing time associated with the selection.

Weighing the static characteristics of the constituents and the runtime characteristics of a speech recognizer using the grammar.

Forming the second processed representation of each constituent includes expanding words in terms of subword units.

Expanding the words in terms of context-dependent subword units such that the expansion of at least some of the words depends on context in proceeding or following words in the sequences of elements defined by the first processed representations of the constituent.

Expanding words adjacent to references of constituents in the first subset in sequences of elements including determining multiple possible expansions of those words according to context of the referenced constituents.

Determining multiple possible expansions of said words in terms of subword units includes limiting said multiple expansions according to context within the second processed representation.

Computing the second processed representation of each constituent includes forming a graph representation of that constituent. Paths through that graph are associated with sequences of elements that include context-dependent subword units and including references to constituents in the first subset of constituents.

Forming a graph representation in which arcs are labeled with the elements and the sequences of elements associated with the paths include labels of arcs on said paths.

Forming a second finite-state transducer (FST) representation of the constituent.

The first processed representation of each of the constituents in the first subset includes a first FST representation of that constituent, and processing the first processed representation of each of the constituents in the first subset to form the second processed representation of that constituent includes applying a composition operation to the first FST representation of that constituent to form the second FST representation of that constituent.

The method further includes accessing the stored configuration data by a speech recognizer, and automatically processing an utterance according to the configuration data. Only some of the second processed representations of the constituents in the first subset are selectively accessed by the speech recognizer according to content of the utterance being processed.

The invention includes one or more of the following advantages.

By selecting only a subset of the constituents of a grammar that are retained by reference in the processed forms of the constituents, the method provides less computation than an approach in which all references to constituents are retained.

Furthermore, by selecting the subset of constituents, the size of the configuration data can be controlled. The size of the configuration data affects not only the size of that data on a static storage device, but can also affect the amount of dynamic memory needed to execute a speech recognizer using that configuration data.

A tradeoff is possible between selecting the a large subset of constituents whose references are not expanded, thereby yielding relatively small configuration data, and selecting a small subset of constituents that yields relatively less computation at runtime.

By expanding subword units according to the multiple expansions that are possible at occurrences of the unexpanded constituents, cross-word subword unit modeling is maintained at the boundaries of those constituents, thereby avoiding loss in speech recognition accuracy as compared to approaches in which cross-word context is not considered at such boundaries.

Other features and advantages of the invention are apparent from the following description, and from the claims.

### DESCRIPTION OF DRAWINGS

FIG. 1 is a block diagram that illustrates a prior art approach in which a context-free grammar (CFG) is fully expanded into a finite-state machine (FSM) grammar at configuration time, and the FSM grammar is processed at recognition time by a speech recognizer;

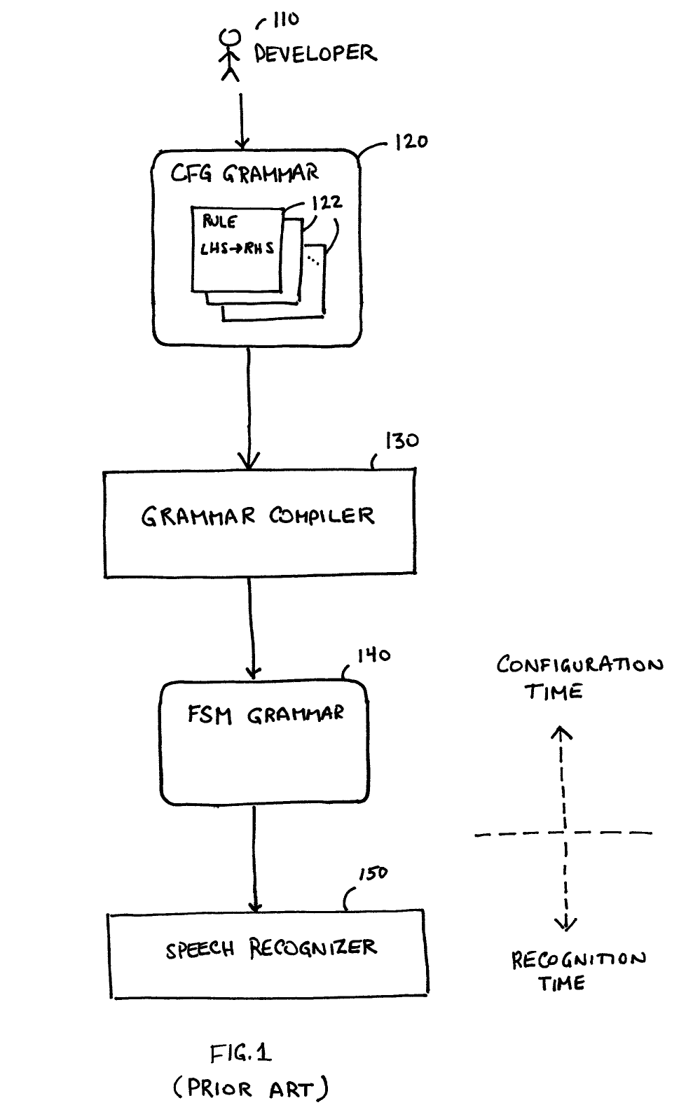

FIG. 2 is a block diagram that illustrates a prior art approach in which a context-free grammar is processed directly by a speech recognizer at recognition time without forming a finite-state machine prior to recognition;

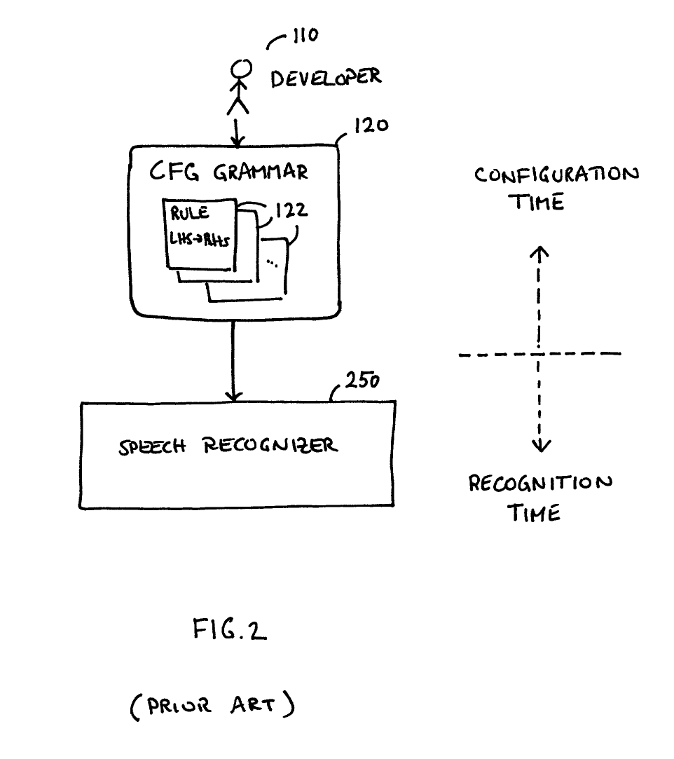

FIG. 3 is a block diagram that illustrates an approach to processing an using a grammar according to the present invention;

FIGS. 4a-c are diagrams that illustrate a simple context free grammar, a fully-expanded finite-state transducer, and a input sequence and corresponding output sequence, respectively;

FIGS. 5a-b are diagrams that illustrate two finite state machines;

FIGS. 6a-b are diagrams that illustrate phone-level transducers;

FIG. 7a is a diagram that illustrates a phone-based transducer, and FIG. 7b is a diagram that illustrates a corresponding context-model-based transducer;

FIG. 8a is a diagram that illustrates a portion of the phone-based transducer for the word-based finite state machine shown in FIG. 5a, and FIG. 8b is a diagram that illustrates a corresponding context-model-based transducer; and

FIG. 9a is a diagram that illustrates a portion of the phone-based transducer for the word-based finite state machine shown in FIG. 5b, and FIG. 9b is a diagram that illustrates a corresponding context-model-based transducer.

### DESCRIPTION

1 Overview

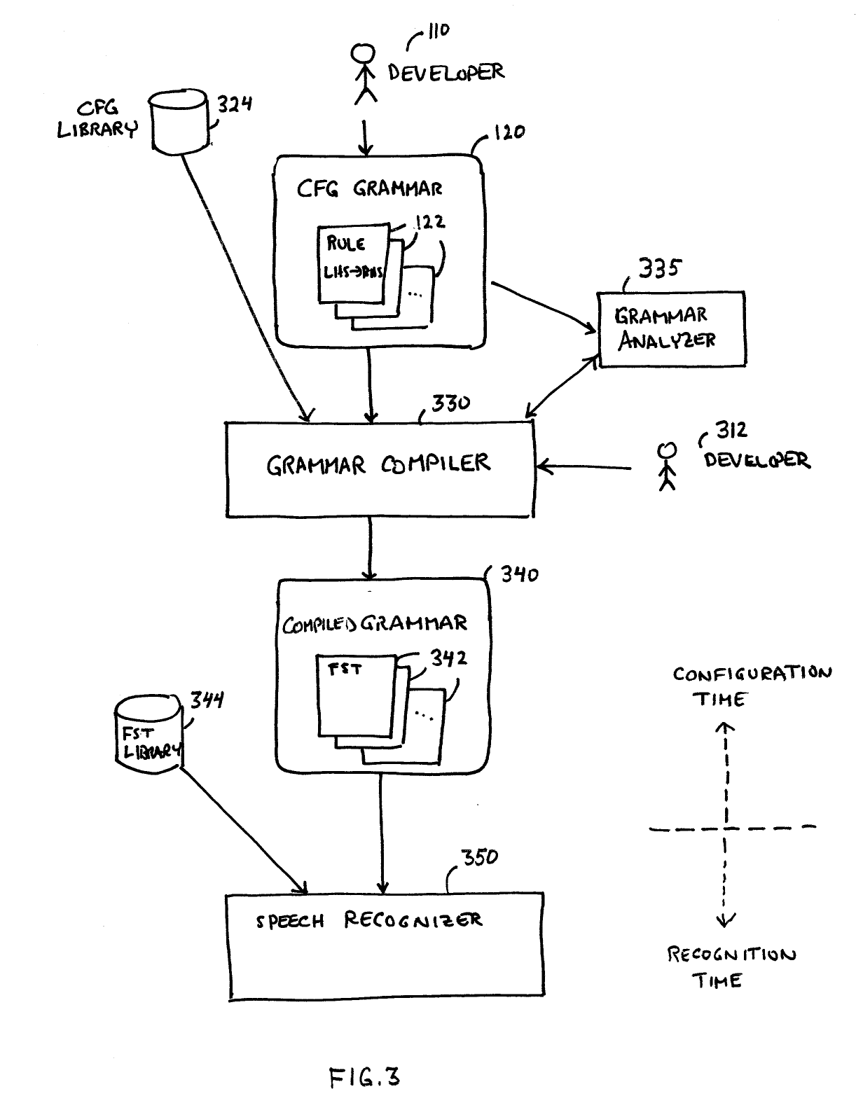

Referring to FIG. 3, a developer 110 specifies a context-free grammar (CFG) 120. CFG 120 includes a number of rules 122, each of which has a left-hand side, which is a non-terminal symbol, and a right hand side, which specifies allowable rewrites of the non-terminal symbol in terms of elements, each of which is a non-terminal symbol or a terminal symbol. The terminal symbols of CFG 120 are words. CFG 120 specifies the set of word sequences (the language) that can be hypothesized during recognition of an utterance. Typically, a speaker is expected to speak an utterance that falls within the specified language.

Developer 110 specifies CFG 120 using a text editing software tool. In alternative embodiments, various types of software systems, for example, systems that support creation of CFG 120 using a graphical interface, or provide aides to specification and verification of the grammar are used.

A grammar compiler 330 processes CFG 120 to produce data that is used by a speech recognizer 350 at the time an utterance is recognized. This data includes a compiled grammar 340, which is similar to a recursive transition network (RTN). Compiled grammar 340 includes a number of separate finite-state transducers (FSTs) 342. Each FST 342 is associated with a different non-terminal symbol that was defined in CFG 120. Each FST 342 includes a graph with arcs that are each labeled with an input symbol and an output symbol. The input symbols include labels of subword units, in particular, labels of context-dependent phones. In the discussion below, such input symbols are referred to as “models.” The input symbols can also include labels of non-terminals that are associated with others of the FST 342. In addition, as is described below, the output symbols of the FST can include markers that are used to construct parses of the output word sequences according to CFG 120 without requiring re-parsing of the word sequence after speech recognizer 150 has completed processing of an input utterance. Furthermore, as is also described below, the output symbols can include markers that are used to identify procedures that are to be executed when particular elements are present in a word sequence produce by the speech recognizer.

In general, there is not a one-to-one correspondence between the FST 342 and CFG rules 122, nor is there typically a separate FST 342 for each non-terminal defined in CFG 122. Rather, each FST 342 represents an expansion of a number of CFG rules 122, and at least some of FST 342 are not expanded fully resulting in arcs in those FST that are labeled with non-terminals rather than phone models.

Grammar compiler 330 determines the nature of this “partial” expansion of CFG 120 into the FST 342 based on input from a developer 312 (who can be but is not necessarily the same person as developer 110) as well as based on an automated analysis of CFG 120 by an automated tool, grammar analyzer 335. As is described more fully below, information provided to grammar compiler 330 by grammar analyzer 335 and developer 312 determine which non-terminals are associated with separate FST 342, and which instances of those non-terminals are not expanded as input symbols on arcs of other of FST 342.

In addition to rules 122, which are specified by developer 110, grammar compiler 330 optionally makes use of a predefined CFG library 324 that includes a number of predefined CFG rules. For example, certain of CFG rules 122 may include non-terminal elements in their right-hand sides that are not defined by any other of rules 122. CFG library 324 may provide the needed rules.

In addition to predefined CFG library 324, speech recognizer 350 can optionally make use of a predefined or dynamically modified FST library 344. For example, a non-terminal element in a right-hand side of a CFG rule 122 may not be defined by either any of CFG rules 122 nor by a rule in CFG library 324. However, such an element may be specified by an FST that is in FST library 344. FST library includes a predefined set of FSTs that speech recognizer 350 can make use of at recognition time.

2 Context-free Grammar 120 Specification

Referring still to FIG. 3, developer 110 in specifying CFG 120 specifies a number of separate CFG rules 122. The left-hand side of each rule specifies a non-terminal that can be expanded using the rule. The right-hand side is specified according to an extended Backus-Naur Form (EBNF), in which alternative and optional elements or sequences of elements are allowed. By convention in the description below, the non-terminal symbols start with the dollar sign character, ‘$’, while terminal symbols (words) are written without any delimiters. Alternative sequences are delimited by a vertical bar, ‘|’, and optional sequences are bracketed by square brackets, ‘[’ and ‘]’. The top-level non-terminal, whose expansion defines the language accepted by the grammar, is denoted by $ROOT.

A simple example, which is carried through the description below, makes use of a CFG 120 that accepts sentences such as “I would like to fly from Albuquerque to Wilmington on the fourth of July.” In particular, the CFG rules 122 in this example are as follows (ellipses indicate sequences of elements that are omitted here for brevity, but which would be included in a complete specification of the rules):

$ROOT=$FLY from $CITY to $CITY [on $DATE]

$FLY=I want to fly | . . . | . . .

$CITY=Albuquerque | Alexandria | . . . | Wilmington

$DATE=$MONTH $DAY | the $DAY of $MONTH

$MONTH=January | . . . | December

$DAY=first | second | . . . | thirty first

In practice, a grammar that specifies the ways in which a speaker might phrase such a request would be significantly more complicated if it were to capture many more possible variations.

In this example, rules are restricted to preclude any recursion. Recursion is the situation in which a rule that defines a non-terminal includes that non-terminal as an element on the right-hand side of that rule, or in the expansion of the right-hand side by recursive expansion of the non-terminal elements. However, restricted forms of recursion are allowed in other examples, and approaches to handling such recursions are noted below.

In addition to specification of the terminal and non-terminal elements on the right-hand side of any rule, the developer can annotate any element with a name of a procedure that is to be executed when that element is present in a hypothesized output. For example, the non-terminal $CITY can be annotated as $CITY_{from}_{_{—}}_{city} resulting in the function from_city( ) being executed when that element is hypothesized by the speech recognizer in an utterance, with the argument to the function corresponding to the output subsequence associated with that element.

3 Grammar Compilation

Grammar compiler 330 processes CFG 120 to produce FST 342 that are used at recognition time by speech recognizer 350. As introduced above, each FST 342 is associated with a different non-terminal defined by CFG rules 122, but each of the non-terminals used in CFG 120 is not, in general, associated with a different one of FST 342.

Each FST 342 includes a graph with arcs between nodes that are each labeled with an input symbol and an output symbol. One node is identified as the starting node and one or more nodes are identified as ending nodes for each of the FST. In the discussion below and in the illustrations, each arc of an FST is labeled ‘a:b’ to denote an input symbol ‘a’ and an output symbol ‘b’ for that arc. The types of input and output symbols of FST 342 are summarized here and discussed more fully below. Input symbols include:

Model labels: each model label identifies a particular context-dependent phonetic model that is expected by the speech recognizer. In general, each model is associated with a particular phone, and identifies one of a number of enumerated context-based variants of that phone.

Non-terminal labels: in addition to model labels, arcs in FST 342 can specify input symbols that are non-terminals. Each non-terminal that appears as a label in an FST 342 is associated with one of the FST 342.

Nulls: arcs in FST 342 can be null, denoted by ‘ε’, ‘eps’, or ‘epsilon’. Such arcs can be traversed during recognition without matching (consuming) any inputs.

The output symbols include:

Word labels: Along any path in FST 342 from the starting node to an ending node, the sequence of input model labels corresponds to a pronunciation of a sequence of words that falls within the language defined by CFG 120. Each of a subset of the arcs on that path has an output word label that identifies that word sequence.

Nulls: Most arcs do not produce any output, and these are labeled with null output symbols

Constituent brackets: In addition to word outputs, some arcs include output symbols that identify the boundaries (“bracket”) of instances of constituent phrases in a word sequence along a path. Constituents correspond to particular non-terminals of CFG 120.

Procedure labels: In addition to outputs that bracket constituents, output procedure labels identify procedures that are to be executed if a path including that arc is hypothesized by the speech recognizer.

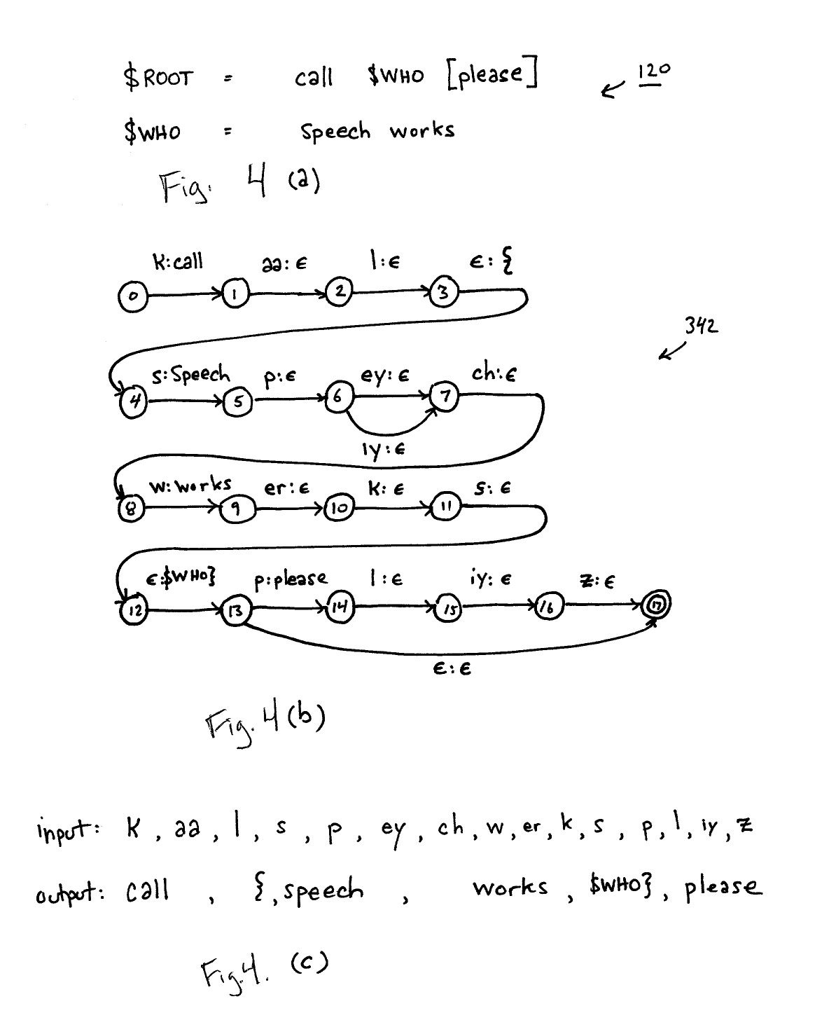

Referring to FIG. 4, an example of a simple CFG 120 and an associated single FST 342 is illustrated. FIG. 4a shows CFG 120 with two non-terminals, $ROOT and $WHO. The language defined by this grammar consists of the two possible sentences “call speech work” and “call speech works please.” FIG. 4b shows a corresponding FST 342 assuming that it is fully expanded such that there are no non-terminals on its arcs. Also, although in general grammar compiler 130 produces FST 342 whose input symbols correspond to context-dependent phone models, for illustration, the inputs symbols in this illustration correspond simply to phones. The starting node is node 0 (by convention) and the ending node is node 17, which has no arcs leaving it.

Nodes 0-3 related to the word “call.” The 0-1 arc is labeled ‘k:call’. The input symbol for that arc is the phone ‘k’ and the output is the word ‘call’. Arcs 1→2 and 2→3 correspond to the phones ‘aa’ and ‘l’ and have null outputs. Therefore, from the starting node, an input ‘k, aa, l’ produces the outputs ‘call, ε, ε’. With the null outputs removed, this produces the partial sentence “call.”

Arcs 3→4 and 12→13 relate to bracketing of the constituent ‘$WHO’. Arc 3ε4 has a null input, and an open bracket output ‘{’. Arc 12→13 has a null input, and a labeled closing bracket ‘$WHO}’. A path from node 3 to node 13 can be identified with the constituent $WHO by matching these brackets.

The arcs from node 4 to node 8 correspond to the word “speech.” Note that there are two alternative pronunciations resulting in two alternative arcs from node 6 to node 7, one with input ‘ey’ and one with input ‘iy’. The arcs from node 8 to node 12 correspond to the word “works” while the arc from node 12 to node 17 correspond to the word “please.” Note that since “please”0 is optional in the grammar, an arc with a null input and a null output joins node 13 to node 17.

Referring to FIG. 4c, an input ‘k, aa, l, . . . iy, z’ is matched to a path from starting node 0 the ending node 17 to produces the output symbols (after null removal) ‘call, {, speech, works, $WHO}, please’. By removing the brackets, the recognized sentence is “call speech works please” and the sub-sequence of words corresponding to the $WHO constituent is identified as “speech works.”

3.1 Processing Stages

Grammar compiler 130 produces compiled grammar 340 in a sequence of steps. These are:

Processing CFG 120 to produce a number of word-level finite state machines G, one corresponding to each of FST 342 that will be produced. The arcs are labeled with words, word-level markers such as constituent brackets, and non-terminal symbols for non-terminals that are not expanded.

Expanding each FSM G to produce an FST, LG, whose input symbols are phonemes and output symbols are words, word-level markers and non-terminals.

Applying phonological expansions to LG to yield phone level FST, PLG, whose input symbols are phones, and whose output symbols are words, word-level markers, and non-terminals.

Applying a context-dependent expansion to PLG to yield an FST, CPLG, whose inputs are models, which correspond to context-dependent phone, and whose output symbols are again words, word-level markers, and non-terminals. The CPLG FST are FST 342 of compiled grammar 340.

In this example, all but the first step are implemented using a composition operator to compose a predefined FST with the input FSM or FST to produce the resulting FST.

3.2 Word-level Processing

As a first step of word level processing, grammar compiler 330 accepts information from grammar analyzer 335 and developer 312 that identifies the non-terminals that are not to be expanded within other constituents and which will be associated with separate FST 342. A description of grammar analyzer 335, which automatically or semi-automatically identifies those non-terminals, is deferred to later in the description below.

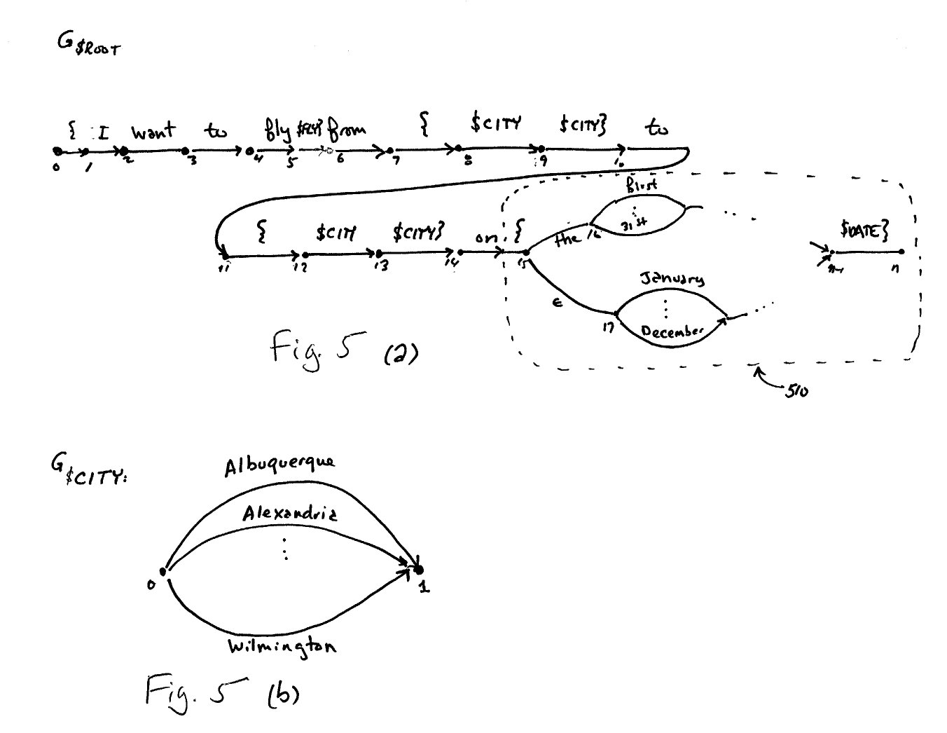

Referring to the example introduced above, which accepts sentences such as “I want to fly from Albuquerque to Wilmington,” FIGS. 5a-b illustrate corresponding word-level FSMs assuming that the non-terminal $CITY has been identified as not to be expanded, while non-terminals $FLY, $DATE, $MONTH and $DAY are expanded. FIG. 5a illustrates the FSM for $ROOT and FIG. 5b illustrates the FSM from $CITY. A sub-graph 510 corresponds to the complete expansion of the non-terminal $DATE, while the arcs from node 8 to 9 and from node 12 to 13 are labeled with the non-terminal $CITY, which is not expanded. Note that if $CITY had been expanded, two instances of the expansion shown in FIG. 5b would be present in the FSM for $ROOT. In practice, many more instances of such a relatively large sub-graph could be present, for example, if $ROOT included the alternatives ‘from $CITY to $CITY’ and ‘to $CITY from $CITY’, there would be four instances. Also note that although $DATE expands to a relatively large sub-graph, it occurs only once in the expansion of $ROOT.

These word-level FSM can be processed in any way that preserves the language of symbols they accept. For example, each word-level graph can be “determinized” to ensure that any node does not have more than one succeeding non-null arc with the same input label. Other procedures, such as introduction and removal of null arcs to modify the graph, can be performed at this stage as well.

3.3 Phoneme- and Phone-level Expansion

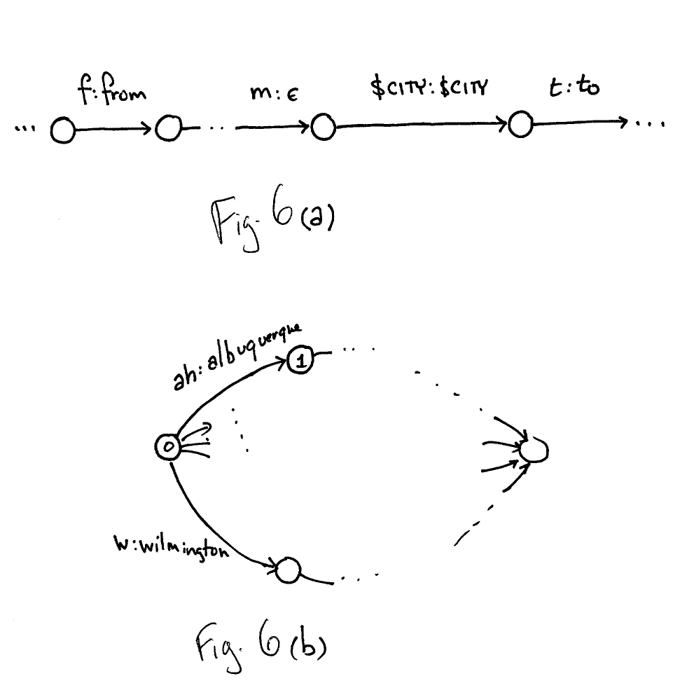

Each of the word-level FST is expanded to produce an FST whose inputs are phonemes and whose outputs are words, word-level markers, and non-terminals. Referring to FIG. 6b, the FST for $CITY is fully expanded to phoneme inputs and word outputs. For instance, the arc from node 0 to node 1 corresponds to the first phoneme of the word “Albuquerque” and is labeled with the phoneme input ‘ah’.

Referring to FIG. 6a, a portion of the expansion of the word-level graph shown in FIG. 5a is illustrated. This portion corresponds to the “from $CITY to” portion of the grammar. From left to right, the first arcs correspond to the word “from”. The next arc corresponds to the un-expanded arc for the non-terminal $CITY. The symbol $CITY is introduced as both the input and the output of the arc. The next arc corresponds to the first phoneme of the word “to.”

This expansion is implemented as a composition LG=L∘G, where L is an FST whose inputs are phonemes and outputs are words. L also passes non-terminal symbols (e.g., $CITY) without modification (input=output), and passes the other word level markers, such as the brackets, with null inputs.

The each of the phoneme level expansions is then processed to produce a phone-based FST whose inputs are phones rather than phonemes. This expansion is again implemented as a composition PLG=P∘LG=P∘L∘G. In the description below, the effect of P is not illustrated and for the purpose of illustration we assume that P does not introduce any additional pronunciations.

3.4 Context-dependent Models

The next processing step involves processing the phone level FST, PLG, to produce a model based FST, CPLG. It is important to note that this processing step considers phone context across word boundaries. In the absence of non-terminals on the arcs of PLG, this processing step is implemented as a composition, CPLG=C∘PLG=C∘P∘L∘G.

In this example, the context of a phone which affects the selection of a model depends on the immediately preceding and the immediately following phone, in what is often referred to as tri-phone modeling. It should be understood that the approach described below is applicable to other contexts, for example, that make use of more preceding and following phones, and make use of other types of contexts, such as word and phrase boundaries.

In the discussion below, a phone ‘b’ that is preceded by a phone ‘a’ and followed by a phone ‘c’ is denoted as having a ‘a_c’ context. In this example, each phone has an enumerated set of context, the selection of which is a deterministic function of its context. That is, all the possible contexts, ‘x₁₃ y’, are mapped into a smaller number of groups. This grouping is based on data, on a priori decisions for example using knowledge of speech, or both. The different models for a particular phone, ‘p’, are enumerated and denoted ‘p.1’, ‘p.2’, . . . .

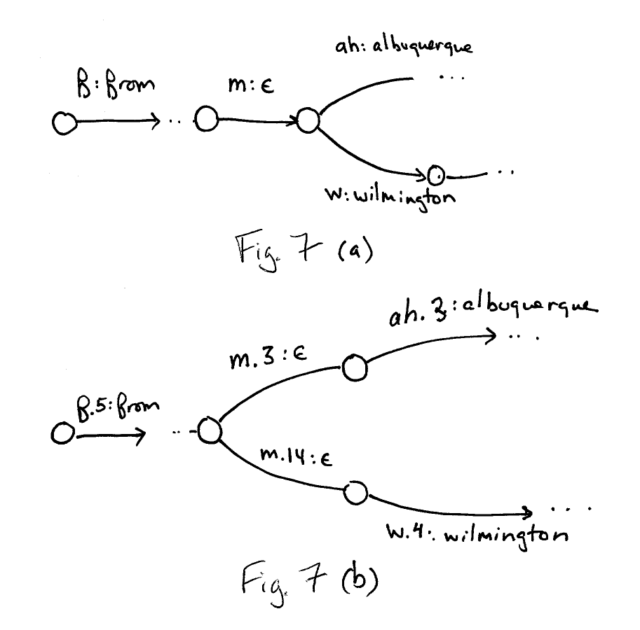

Before considering the context-dependent expansion in the presence of arcs labeled with unexpanded non-terminals, consider the phone-level FST shown in FIG. 7a for a portion of a single word-level grammar corresponding to “from” followed by either “Albuquerque” or “Wilmington.” In FIG. 7b, we assume that the ‘m’ in “from” yields a different model in the context for the first phone of “Albuquerque” than in the context of the first phone of “Wilmington.” These contexts are labeled ‘m.3’ and ‘m.14’, respectively. The number of nodes in the FST generally increases in this step to accommodate the distinctive models for different context of the phones in the graph.

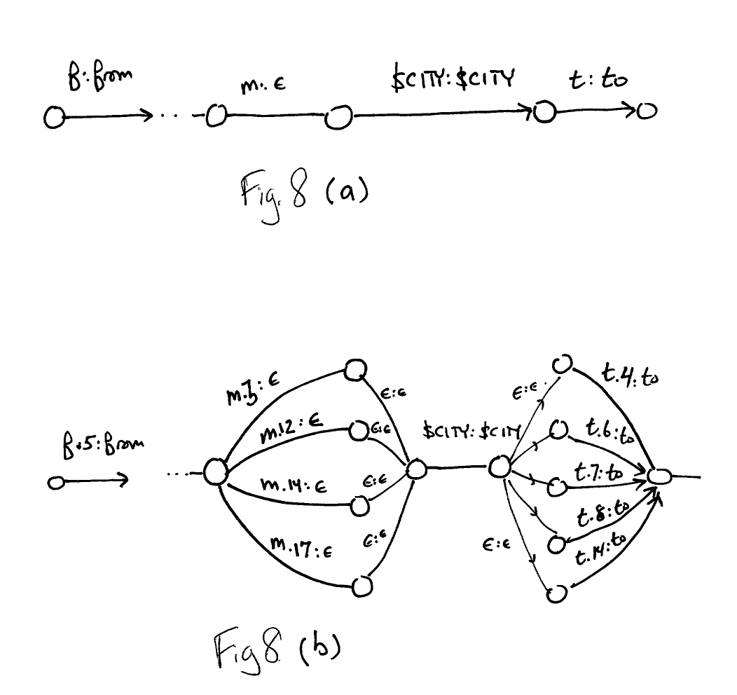

Now referring to FIG. 8a, a similar portion of the phone level FST in our example corresponds to the portion of the grammar “from $CITY to.” Note that in the context-dependent expansion, we account for the possible expansions of $CITY. In this embodiment, the grammar compiler does not make use of the actual starting or ending phone of the expansion of $CITY in performing the context-dependent expansion of the FST. Referring to FIG. 8b, the phone ‘m’ is expanded into a number of contexts. Note that since the preceding context, in this case the word “from,” is known, the set of possible contexts is restricted to be consistent with that preceding context. However, since the following context is not known, a number of different contexts are expanded. In this illustration, ‘m’ is expanded to ‘m.3’, ‘m.12’, ‘m.14’, and ‘m.17’. Note that ‘m.3’ and ‘m.14’ are actually needed for the contexts of “Albuquerque” and “Wilmington” as shown in FIG. 7b. The resulting expansions are linked by null arcs to the starting node of $CITY. These null arcs include annotations that are used at recognition time and that indicate the particular contexts they are appropriate for.

A similar processing occurs for the first phone of the following word “to.” Various possible contexts for the phone ‘t’ are illustrated based on the unknown ending phones of $CITY and the known following phones of the word “to.”

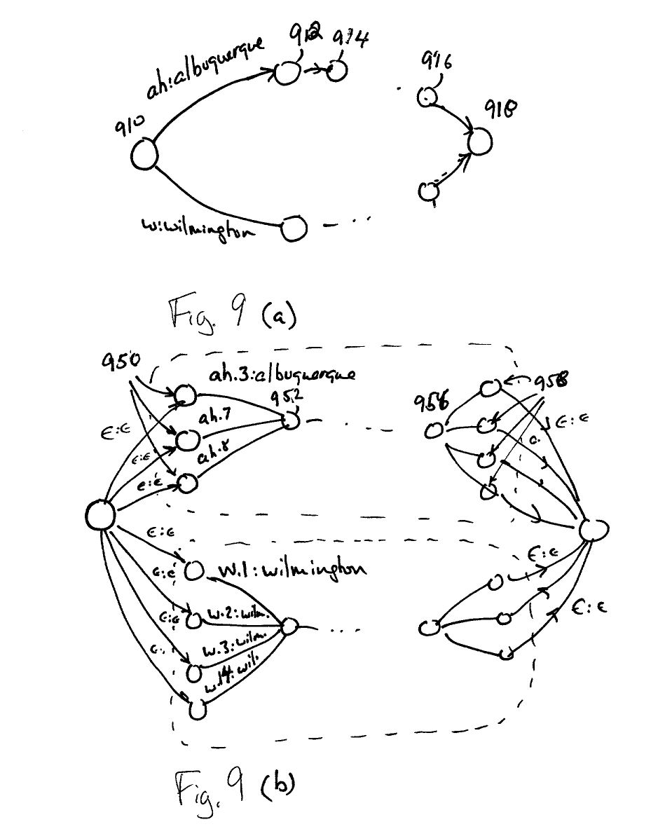

Referring to FIG. 9a and FIG. 9b, a similar context processing is performed for the FST for $CITY. In FIG. 9a, the first arc of “Alburqueue” from node 910 to node 912 is expanded based on the unknown preceding context in which the $CITY is used. Note that in this example, $CITY follows both “from” and “to” in different instances in the grammar. Referring to FIG. 9b, nodes 950 correspond to node 910 and the multiple arcs from nodes 950 to node 952 have the multiple contexts the first phone of “Albuquerque” may be used in. Similarly, the last arc of each word is expanded to account for the unknown following context.

This expansion is performed using a composition operation with an FST C, as introduced above.

4 Recognition

Referring back to FIG. 3, speech recognizer 350 makes use of the multiple FST 342. In this example, there are only two FST, one for $ROOT and one for $CITY. In processing an input utterance, speech recognizer 350 keeps track of a state the grammar is in, based on past input, and uses compiled grammar 340 to identify allowable next models based on the state. In the case that a compiled grammar is fully expanded, the state corresponds to the node in the single FST of that compiled grammar. Here, speech recognizer 350 recursively enters (“calls”) the subsidiary FST when it encounters non-terminal arcs during recognition in an RTN approach, and maintains a calling “stack” along with the state.

In the example introduced above, suppose the speech recognizer has just processed the input corresponding to the ‘m’ in “from”, then it may have four hypotheses corresponding to having just consumed the arcs labeled ‘m.3’ through ‘m.17’ shown in FIG. 8b. In order to determine what allowable context-dependent models to consider next, the recognizer “calls” the $CITY FST shown in FIG. 9b. Suppose for illustration that $CITY includes only the names “Albuquerque” and “Wilmington”. In entering $CITY, the speech recognizer dynamically determines that the node following ‘m.3’ can propagate to the arc labeled ‘ah.3’ and the node following ‘m.14’ can propagate to the arc labeled ‘w.4’, and in this simple example, the nodes following ‘m.12’ and ‘m.17’ do not propagate to any arc in the $CITY FST. After propagating into $CITY, the recognizer maintain a context (call stack) so that when it reaches the ending node of the $CITY FST, it propagates to the correct arcs in the $ROOT FST.

5 Post-processing

Based on processing an entire utterance, speech recognizer 350 hypothesizes one path, or alternatively multiple (“N-best”) paths, though the recursively expanded FSTs, and for each hypothesized path produces the corresponding sequence of output symbols, ignoring the null outputs. As introduced above, these output symbols include words, and opening and closing brackets for constituents, which are used to parse the output without having to process the word sequence with CFG 120 after recognition.

As introduced above, elements in a right-hand side of a CFG rule 122 can be annotated with procedure names. The mechanics of this are not illustrated in the examples above. If an element is annotated with a procedure label, an arc with an opening bracket is introduced in the word graph before the element and an arc with a closing bracket and an identifier of the procedure is introduced after the element. In post-processing the hypothesized output, the speech recognizer locates these procedure brackets and invokes the identified procedures using the bracketed output subsequence as an argument to the procedure. Typically an application program has invoked the speech recognizer, and the procedures that are automatically called are “callback” procedures in the application that are used to process the hypothesized output. For example, if a constituent corresponds to the ways a currency amount (e.g., “a dollar fifty”) are spoken, the callback procedure may process the subsequence of words to automatically fill in a value for the stated dollar amount.

6 Selection of Non-expanded Non-terminals

A number of alternative approaches are used alone or in combination to select the non-terminals which are not expanded during grammar compilation. In a first approach, developer 312 provides a list of those non-terminals to grammar compiler 330. For example, developer 312 may select these non-terminals based on knowledge that they result in large subgrammars, but are not often used in practice by a speaker. Since they are not often used, speech recognizer 350 would not often incur the overhead of calling the nested FST for that non-terminal. Another criterion used by developer 312 might be based on a combination of a relative large size of the expansion of the non-terminal and a large number of instances of the non-terminal in the grammar.

The selection process is alternatively automated using grammar analyzer 335. For example, a criterion based on the overall size of compiled grammar 340 and an estimated overhead for processing the nested calls at run-time may be used. Grammar analyzer 335 processed CFG 120, and optionally processes a corpus of typical utterances in determining the non-terminals to select according to the criterion.

7 Alternative Examples

In alternative examples, the approach described above is used in an RTN approach in which each non-terminal is associated with a different FST 342. The crossword modeling approach described above is used in “calling” the nested grammars.

In another example, some of FST 342, or equivalently FST in FST library 344 are not known at configuration time. For example, non-terminals may be dynamically expanded based on the identity of the speaker or on external context such as the time of day or the area code from which a speaker is calling.

8 Hardware and Software Environment

The approaches described above are implemented in a number of different hardware and software architectures. Software, which is stored on computer readable media such as magnetic or optical disks, or which is accessed over a communication medium such as a data network, includes instructions for causing processors to perform the various steps. These processors can be general-purpose processors, such as Intel Pentium processors, and the software can execute under the control of a general-purpose operating system such as Microsoft Windows NT, or a variant of the UNIX operating system. Alternatively, the processors can be special purpose and the operating systems can be special-purpose operating systems. The instructions can be machine-level instructions. Alternatively, the instructions are higher-level instructions, such as Java byte codes or program language statements that are interpreted at runtime. The functions for configuration time and for recognition time can all be performed on a single computer. Alternatively, the configuration time steps may be performed on one or a number or computers and the recognition performed on another computer or set of computers. Information can be transferred from the configuration computer to the recognition computer over a communication network or using physical media. Multiple computers can be used for the configuration steps or the recognition steps, and some configuration steps may be performed on the recognition computer. For example, determining runtime characteristics of a grammar may be performed on a computer hosting the recognizer, with these determined runtime characteristics being fed back to a configuration computer. Such an approach can include profiling execution of the recognizer and feeding back the profiling results to the grammar compiler.

Other embodiments are within the scope of the following claims.

What is claimed is:

1. A method comprising:
processing a specification of each of a first subset of at least some of the constituents of a grammar, each of the constituents defining sequences of elements that include words and references to constituents of the grammar, the processing of each of the specifications including
forming a first representation of the constituent by expanding references to constituents in a second subset of the constituents according to the specifications of said constituents in the second subset, the second subset being different from the first subset, and retaining references to constituents in the first subset without expanding all of said references.

2. The method of claim 1 further comprising accepting a specification of the grammar as a phrase-structure grammar.

3. The method of claim 2 wherein accepting the specification of the grammar includes accepting specifications of the constituents of the grammar, said specifications including rewrite rules that specifies allowable substitutions of references to said constituents as sequences of elements associated with said constituents.

4. The method of claim 2 wherein accepting the specification of the grammar includes accepting a specification of a context-free grammar.

5. The method of claim 2 wherein accepting the specification of the grammar includes accepting said specification in Backus Naur Form (BNF).

6. The method of claim 1 further comprising selecting members of the first subset of the constituents.

7. The method of claim 6 wherein selecting the members includes selecting constituents according to static characteristics of the grammar.

8. The method of claim 7 wherein selecting the constituents includes selecting constituents according to a size of processed representations of said constituents.

9. The method of claim 7 wherein selecting the constituents includes selecting constituents according to a number of occurrences of said constituents in the grammar.

10. The method of claim 6 wherein selecting the members includes selecting constituents according to runtime characteristics of a speech recognizer using the grammar.

11. The method of claim 10 wherein selecting the constituents includes selecting said constituents according to a number of uses of said constituents by the speech recognizer.

12. The method of claim 10 wherein selecting the constituents includes selecting said constituents according to an expected processing time associated with the selection of said constituents.

13. The method of claim 11 wherein selecting the constituents according to the expected processing time associated with the selection of said constituents includes selecting said constituents according to a change in expected processing time associated with the selection.

14. The method of claim 6 wherein selecting the constituents includes a weighing of the static characteristics of said constituents and the runtime characteristics of a speech recognizer using the grammar.

15. The method of claim 1 wherein processing of each of the specifications further includes:
forming a second representation of the constituent from the first representation, the second representation defining elements that include subword units and references to constituents in the first subset.

16. The method of claim 15 wherein forming the second processed representation of each constituent includes expanding words in terms of subword units.

17. The method of claim 16 wherein expanding words in terms of subword units includes expanding said words in terms of context-dependent subword units such that the expansion of at least some of the words depends on context in preceding or following words in the sequences of elements defined by the first processed representation of said constituent.

18. The method of claim 17 wherein expanding words in terms of subword units further includes expanding words adjacent to references of constituents in the first subset in sequences of elements including determining multiple possible expansions of said words according to context of the referenced constituents.

19. The method of claim 18 wherein determining multiple possible expansions of said words in terms of subword units includes limiting said multiple expansions according to context within the second processed representation.

20. The method of claim 16 wherein computing the second processed representation of each constituent includes forming a graph representation of said constituent, wherein paths through said graphs are associated with sequences of elements, said elements including context-dependent subword units and including references to constituents in the first subset of constituents.

21. The method of claim 20 wherein forming the graph representation includes forming a graph representation in which arcs are labeled with the elements and the sequences of elements associated with the paths include labels of arcs on said paths.

22. The method of claim 21 wherein forming the graph representation includes forming a second finite-state transducer (FST) representation of the constituent.

23. The method of claim 22 wherein the first processed representation of each of the constituents in the first subset includes a first FST representation of said constituent, and processing the first processed representation of each of the constituents in the first subset to form the second processed representation of said constituent includes applying a composition operation to the first FST representation of said constituent to form the second FST representation of said constituent.

24. The method of claim 1 further comprising:
storing configuration data computed in processing each of the specification;
accessing the stored configuration data by a speech recognizer; and
automatically processing an utterance according to the configuration data.

25. The method of claim 24 further comprising:
selectively accessing only some of the second processed representations of the constituents in the first subset according to content of the utterance being processed.

26. A method for processing a grammar comprising:
selecting a subset of constituents of the grammar;
processing a specification of the grammar, including processing references to constituents in the subset differently than references to constituents not in the subset.

27. The method of claim 26 wherein processing references in the subset differently that references not in the subset includes expanding all references not in the subset and not expanding all references that are in the subset.

28. Software stored on machine-readable media for causing a processing system to:
process a specification of each of a first subset of at least some of the constituents of a grammar, each of the constituents defining sequences of elements that include words and references to constituents of the grammar, the processing of each of the specifications including
forming a first representation of the constituent by expanding references to constituents in a second subset of the constituents according to the specifications of said constituents in the second subset, the second subset being different from the first subset, and retaining references to constituents in the first subset without expanding all of said references.
